(19) United States
(12) Patent Application Publication
(10) Pub. No.: US 2010/0175224 A1
(43) Pub. Date: Jul. 15, 2010

(54) SHAFT SLEEVE FOR PACKING FILM

(76) Inventor: Chun-Tsai CHEN, Tainan Hsien (TW)

Correspondence Address: Chun-Tsai CHEN, P. O. BOX 90, Tainan City, 70499, TW

(21) Appl. No.: 12/353,989

(22) Filed: Jan. 15, 2009

(51) Int. Cl. B25G 1/10

(52) U.S. Cl. 16/421

(57) ABSTRACT

A shaft sleeve for packing film, made of soft plastic, includes a grip provided with a flange at one end and an accommodating chamber in the interior. The accommodating chamber has inner wall fixed with plural oblique serrated bars respectively having one side formed with an inclined plane and another side provided with an engage surface. To pack articles with packing film, simply fit two shaft sleeves on the shaft rod 21 of the packing film to actuate the shaft rod to rotate clockwise through the inclined planes on the oblique serrated bars. To stop packing or apply force for tightening the packing film, only forcefully grip and press the shaft sleeves to let the engage surfaces of the oblique serrated bars counterclockwise engage and stop the shaft rod from rotating, able to pack articles tightly and prevent the packing film from rewinding and becoming slack.

### BACKGROUND OF THE INVENTION

1. Field of the Invention

This invention relates to a shaft sleeve for packing film, particularly to one fitted on the opposite ends of the shaft rod of the packing film to be gripped by a user's hands for facilitating carrying out packing work.

2. Description of the Prior Art

Conventionally, when packing articles with packing film, a user generally grips the shaft rod of the packing film with hands to carry out packing work. However, packing articles in this way, the shaft rod and the user's hands may produce friction and cause injury to the hands, and it is likely to apply force unevenly and fail to pack the article completely. In addition, in the course of packing, the packing film may fall off if the user's hands are wet with perspiration, thus affecting packing quality.

### SUMMARY OF THE INVENTION

This invention is devised to offer a shaft sleeve for packing film, able to tightly and conveniently pack articles with packing film.

The feature of this invention is that the shaft sleeve is provided with a grip formed with an accommodating chamber in the interior, and a plurality of oblique projecting strips are formed on the inner wall of the accommodating chamber and respectively have one side formed with an inclined plane and another side disposed with an engage surface.

### BRIEF DESCRIPTION OF DRAWINGS

This invention will be better understood by referring to the accompanying drawings, wherein:

FIG. 1 is a perspective view of a shaft sleeve for packing film in the present invention;

FIG. 2 is a side cross-sectional view of the shaft sleeve for packing film in the present invention;

FIG. 3 is a perspective view of two shaft sleeves respectively fitted on the opposite ends of the shaft rod of the packing film in the present invention;

FIG. 4 is a perspective view of the shaft sleeves gripped with hands to carry out packing work in the present invention;

FIG. 5 is a cross-sectional view of the shaft sleeve in a using condition in the present invention; and

FIG. 6 is a cross-sectional view of the shaft sleeve pressed forcefully with hands to have its inner oblique serrated bars engaged with the shaft rod for stopping packing work in the present invention.

### DETAILED DESCRIPTION OF THE PREFERRED EMBODIMENT

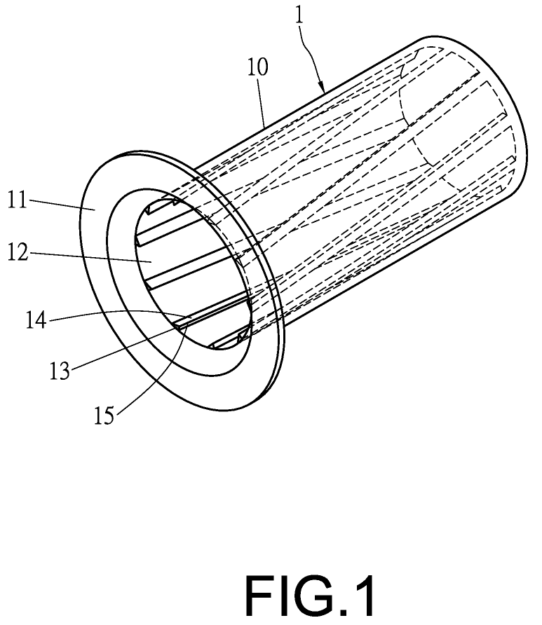

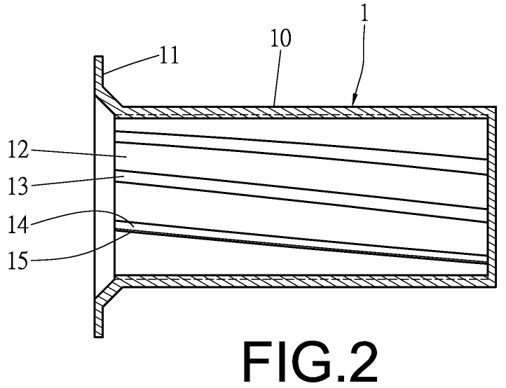

A preferred embodiment of a shaft sleeve 1 made of soft plastic and used for carrying out packing in the present invention, as shown in FIGS. 1 and 2, includes a grip 10 provided with a flange 11 at one end and an accommodating chamber 12 in the interior. The accommodating chamber 12 has an inner wall formed thereon with a plurality of oblique projecting strips 13 respectively having one side formed with an inclined plane 14 and another side disposed with an engage surface 15.

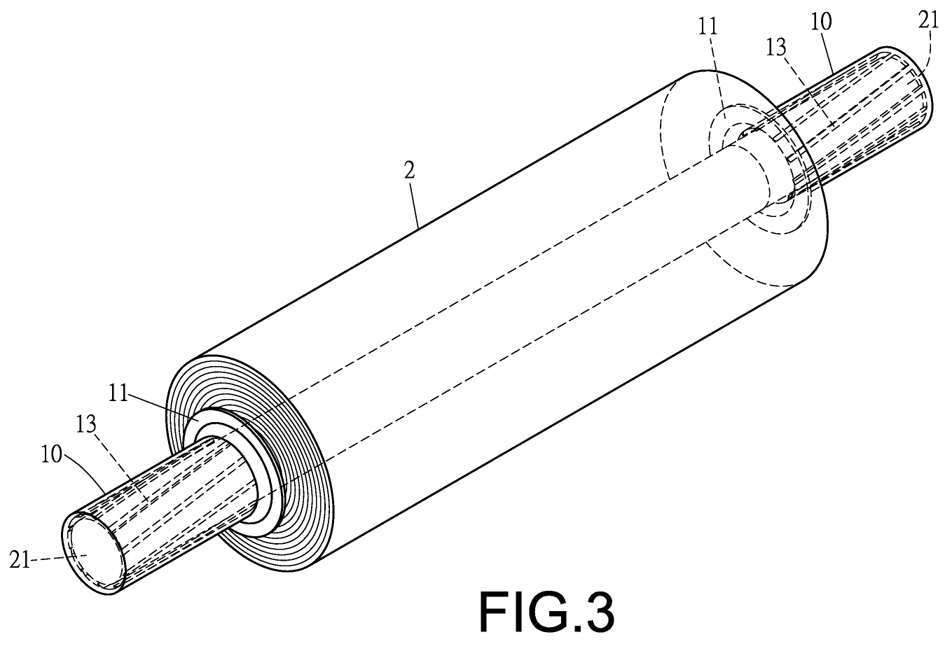

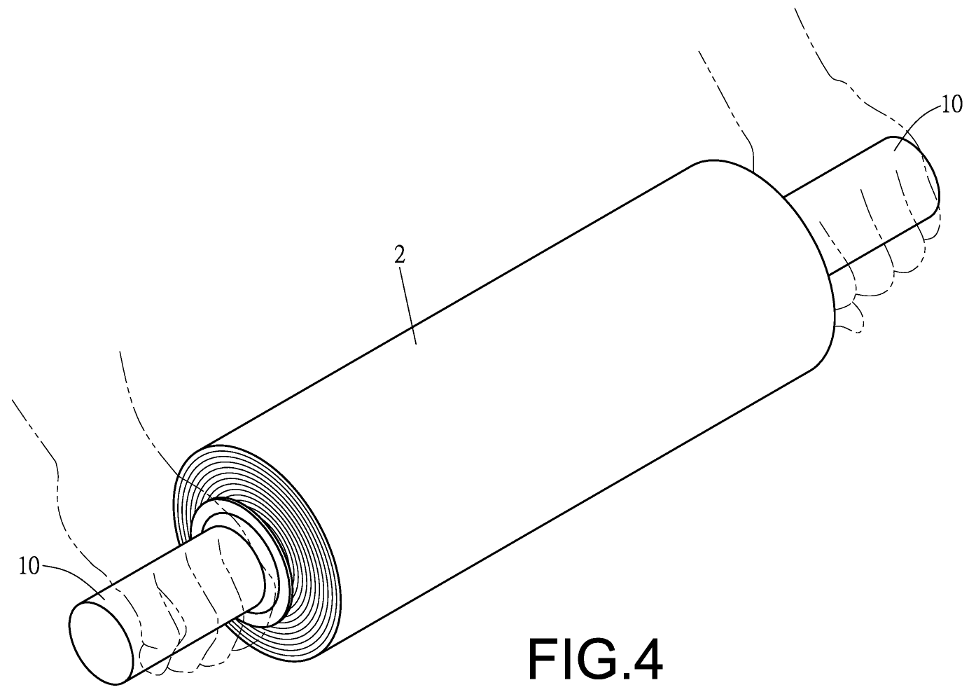

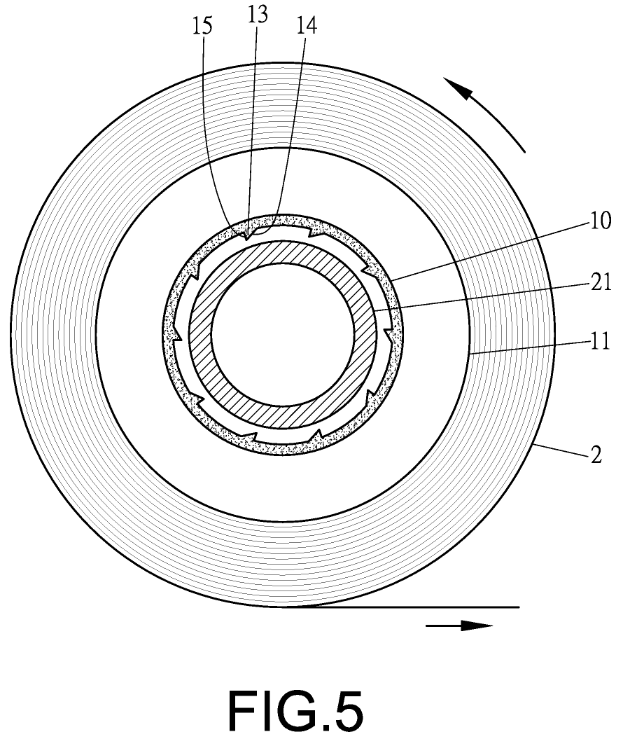

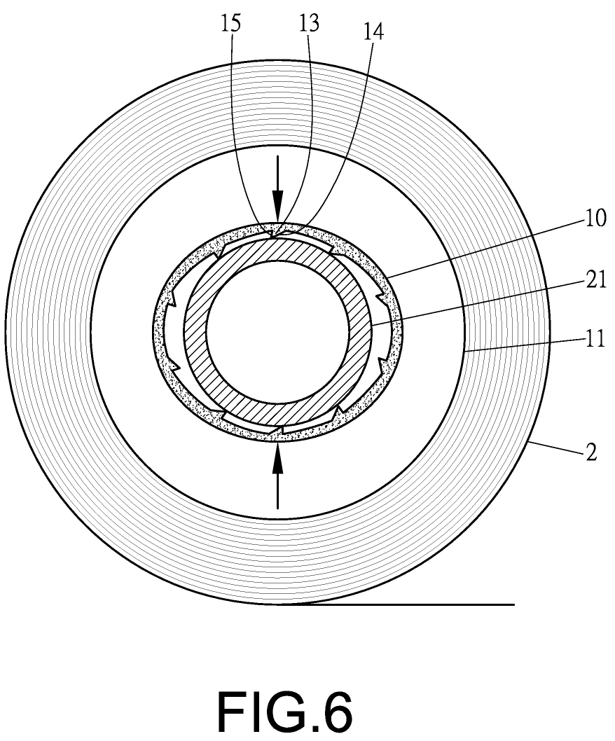

During packing articles with packing film, referring to FIGS. 3, 4 and 5, firstly, two shaft sleeves 1 are respectively fitted on the opposite ends of the shaft rod 21 of the packing film 2. The oblique projecting strips 13 inside the two opposite shaft sleeves 1 are disposed coaxially and reversely. All a user has to do is to hold the grips 10 of the two shaft sleeves 1 with hands to actuate the shaft rod 21 of the packing film 2 to rotate clockwise along the inclined planes 14 on the oblique projecting strips 13 inside the opposite shaft sleeves 1, thus able to carry out packing work smoothly and avoid a user's hands getting injured by friction and prevent the packing film 2 from falling off. To stop the packing film 2 from packing or apply force for tightening the packing film 2, referring to FIG. 6, only forcefully grip and press the shaft sleeves 1 to let the engage surfaces 15 on the oblique serrated bars 13 inside the shaft sleeves 1 counterclockwise engage and stop the shaft rod 21 of the packing film 2 from rotating, thus able to pack the article tightly and conveniently and prevent the packing film 2 from rewinding and becoming slack.

While the preferred embodiment of the invention has been described above, it will be recognized and understood that various modifications may be made therein and the appended claims are intended to cover all such modifications that may fall within the spirit and scope of the invention.

What is claimed is:

1. A shaft sleeve for packing film, said shaft sleeve made of soft plastic and comprising a grip, said grip having one end provided with a flange, said grip formed with an accommodating chamber in the interior: and
characterized by a plurality of oblique projecting strips formed on an inner wall of said accommodating chamber of said grip of said shaft sleeve, each said oblique projecting strips having one side formed with an inclined plane and another side provided with an engage surface.
